(19) United States
(12) Patent Application Publication
(10) Pub. No.: US 2007/0120380 A1
(43) Pub. Date: May 31, 2007

(54) Pivoting push latch

(76) Inventor: Joseph J. Bella, Plainfield, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/541,049

(22) Filed: Sep. 29, 2006

Related U.S. Application Data
(60) Provisional application No. 60/737,678, filed on Nov. 17, 2005.

(51) Int. Cl. E05C 19/00

(52) U.S. Cl. 292/300

(57) ABSTRACT

A push-to-open and push-to-close latch mechanism for a latchable structure includes a protrusion movable in an arc and a push-push latch configuration that moves in an arc while opening and closing the structure.

### CROSS-REFERENCE TO RELATED APPLICATIONS

The present regular United States Patent Application claims the benefits of U.S. Provisional Application Ser. No. 60/737,678, filed on Nov. 17, 2005.

### FIELD OF THE INVENTION

The present invention relates generally to latch mechanisms and, more particularly, the invention pertains to latch mechanisms that are pushed to open and pushed to close.

### BACKGROUND OF THE INVENTION

Latch mechanisms that are pushed to open and pushed to close are used extensively in many constructions and assemblies and have received broad acceptance in the automotive industry. So called “push-push latches” are known for use on container holders, storage compartments, ashtrays, sunglass bins and other compartments within automobiles. Such mechanisms are used also in the electronics industry for stereos, televisions, video devices and the like which have compartments and things for which it is convenient and/or desirable to use a pushing motion for both latching and unlatching the device. A push-push latch is operated by pushing the drawer, door, tray or other device both to open and close the object. For example, a cup holder in an automobile can be released from a closed or stored position by pushing it inwardly in its mounting. The inward movement of the cup holder releases the holder from its latching mechanism, allowing it to spring outwardly for use. From the extended or exposed position for use, the holder is returned to a stored condition by again pushing the holder inwardly in its mounting, causing the latch to engage the holder, retaining it in a stored position.

Some such push-push latch mechanisms have been relatively complex, with many component parts. As a result, such mechanisms are expensive to manufacture, assemble and install.

In a known push-push latch design directed at simplifying the latch, a latching body includes a mouth, an inlet channel in communication with the mouth and an outlet channel in communication with the mouth. A detent nest is provided for receiving a protrusion and holding the protrusion in a locked condition. Cam means disposed between the inlet and outlet channels direct the protrusion into the nest from the inlet channel and direct the protrusion from the nest into the outlet channel upon successive push operations. The latching body is held in straight slots along which it traverses during operation. Accordingly, the latching body and protrusion are movable in separate paths substantially orthogonal to each other.

While a sliding push-push latch as described above has achieved acceptance in some applications, in other applications the use thereof has been problematic. One such difficulty occurs when the latch is used on a door, bin or the like which pivots open from a fixed axis. When movement is straight line, the sliding latch mechanism described works easily. However, when a bin or the like is moved in an arc, pivoting about an axis, the pivotal movement must be translated to straight line movement for operating the latch. The result can be increased operating forces required to push the bin at both the opening and closing functions.

Further, it is sometimes desirable to have a two stage operation wherein the bin or the like can be secured at an intermediate position between fully opened and fully closed positions. For example, in an automobile, the first position can expose a mirror, and the second position can expose a storage bin behind the mirror.

### SUMMARY OF THE INVENTION

The present invention provides a push-push latch mechanism wherein the latching body is secured about an axis and pivots about the axis as a part of the device on which it operates pivots around another axis when moved between closed and open positions.

In one aspect thereof, the present invention provides a latch with a protrusion movable in an arc, and a push-push latch configuration having an entrance wall portion, an exit wall portion and a redirecting feature between the entrance wall portion and the exit wall portion. A nest has a settling point for receiving the protrusion. The latch configuration is pivotal about an axis for movement in an arc as the protrusion traverses paths entering and exiting the latch configuration.

In another aspect thereof, the present invention provides a latchable structure with a first component having a hole and an arcuate slot, and a latch body having first and second faces. The first face has a snap connector disposed in the hole and a boss disposed in the arcuate slot. The second face has a push-push latch configuration including a latch nest. The latch body is rotatable about the snap connection in the hole, the rotation being limited by the boss in the arcuate slot. A second component is movable about a pivotal axis for opening and closing the structure. The second component has a protrusion movable in an arc and operating within the push-push latch configuration including being retained in the latch nest to secure a position of the second component relative to the first component.

In a still further aspect thereof, the present invention provides a method for operating a latch with steps of moving a protrusion in an arc; providing a push-push latch configuration; and tilting the latch configuration from one position to another position about a rotational axis while moving the protrusion within the latch configuration

An advantage of the present invention is providing a push-push latch mechanism that operates easily and conveniently in a pivoting environment where the device to be latched moves in an arc about an axis.

Another advantage of the present invention is providing a push-push latch mechanism that operates smoothly and easily.

A further advantage of the present invention is providing a push-push latch having multiple stops including a fully closed and a partly closed stop position.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an elevational view of a bin having a push-push latch mechanism in accordance with the present invention;

FIG. 2 is a perspective view of one side of a latch body in the latch mechanism shown in FIG. 1;

FIG. 3 is an elevational view of the latch body shown in FIG. 2, but showing the side opposite the side shown in FIG. 2;

FIG. 4 is a fragmentary elevational view of a portion of the bin illustrated in FIG. 1, with the latch body in one operating position;

FIG. 5 is a fragmentary view similar to that of FIG. 4, but illustrating the latch body in another operating position;

FIG. 6 is a fragmentary view similar to that of FIGS. 4 and 5, but illustrating the latch body in a still further operating position;

FIGS. 7, 8, 9 and 10 illustrate sequential positions during operation of the latch mechanism, with FIG. 7 illustrating the start of a latch operation, FIG. 8 illustrating a further step in the latching process, FIG. 9 illustrating the latched position and FIG. 10 illustrating movement toward an unlatched condition; and

FIG. 11 illustrates another embodiment of the push-push latch mechanism in accordance with the present invention having multiple stops.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

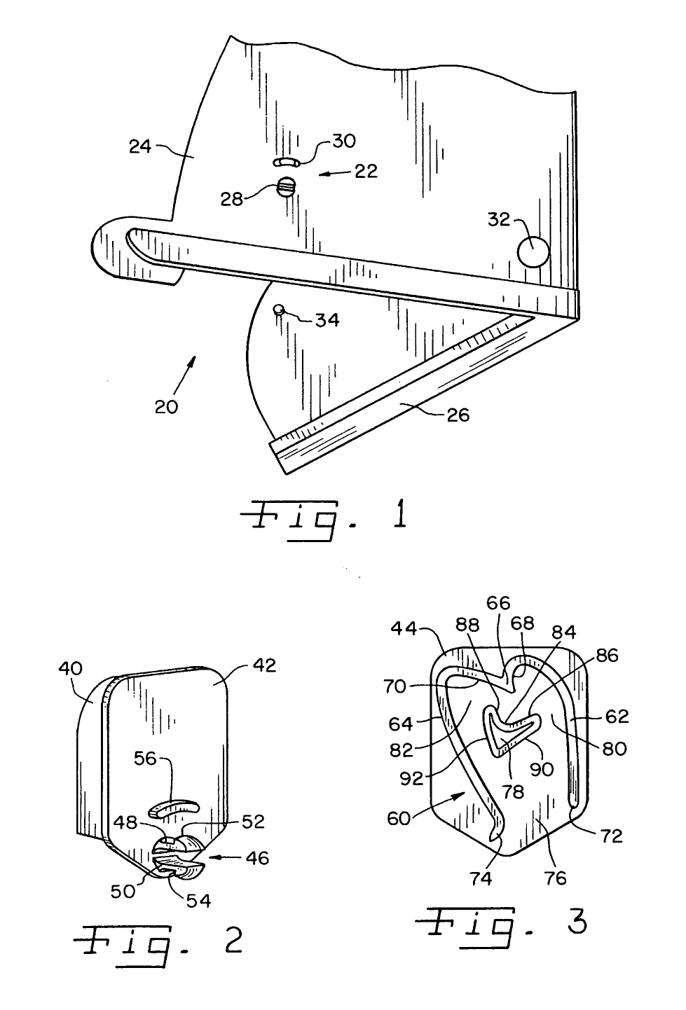

Referring now more specifically to the drawings and to FIG. 1 in particular, numeral 20 designates a latchable structure, which in the exemplary embodiment is a bin assembly, having a latch 22 in accordance with the present invention installed therein for securing the bin in a closed position. It should be understood that the exemplary illustration of bin 20 is merely for illustrative purposes, and the present invention can be used on a variety of objects and devices of different shape and for different purpose than bin 20. Generally, the present invention can be used for latching a structure having a first component and a second component movable relative to the first component.

Bin 20 includes a first component 24, which is a housing 24, and a second component 26, which is a door 26. Housing 24 is provided with a hole 28 and an arcuate slot 30 both for receiving latch 22, as will be described in greater detail hereinafter. Door 26 is pivotally connected to housing 24 about an axis 32. Door 26 further includes a pin or protrusion 34 to work with latch 22.

Latch 22 is a body 40 of material such as molded plastic or the like and includes a mounting face 42 on one side of body 40 and an operating face 44 on the opposite side of body 40. Mounting face 42 includes a snap connector 46, which in the exemplary embodiment has two deflectable legs 48, 50 with outwardly projecting lips 52, 54, respectively, for a snap-fit engagement with housing 24 via hole 28. Mounting face 42 further defines a boss 56 received in arcuate slot 30, for limiting rotation of latch 22 relative to housing 24 about the axis defined by the engagement of snap connector 46 in hole 28. Boss 56 is arcuately shaped and is selected of a length with respect to a length of arcuate slot 30 to restrain rotation of latch 22 to extreme positions relative to the opposite ends of arcuate slot 30 for proper operation within the environment of bin 20. The ends of slot 30 are fixed stops for the rotation of body 40.

Operating face 44 defines a so-called push-push latch configuration 60 which cooperates with pin or protrusion 34 for a push-to-latch, push-to-unlatch opening and closing procedure for bin 20. Latch configuration 60 includes an outer wall having an entrance wall portion 62, an exit wall portion 64 and a redirecting feature 66 having both an entrance side 68 and an exit side 70. Redirecting feature 66 interconnects entrance wall portion 62 and exit wall portion 64 so that a continuous barrier is provided from an end 72 of entrance wall portion 62 to an end 74 of exit wall portion 64. Ends 72 and 74 are spaced from each other, defining a portal 76 through which protrusion 34 passes during opening and closing procedures.

A latch nest 78 is disposed between and spaced from entrance wall portion 62 and exit wall portion 64, and is beneath and spaced from redirecting feature 66. Accordingly, an entrance path 80 and an exit path 82 are defined between latch nest 78 and entrance wall 62, exit wall 64 and redirecting feature 66, leading from and toward the area of portal 76.

Latch nest 78 is a generally heart-shaped configuration forming a settling point 84 defining the secured position for pin or protrusion 34 when bin 20 is closed. An entrance surface 86 and an exit surface 88 meet to define settling point 84 therebetween. On an opposite side from settling point 84, latch nest 78 includes an entrance guide wall 90 and an exit guide wall 92. Although latch nest 78 is shown as being heart shaped, it can be any shape, such as in the shape of a check mark or backwards “L”, that allows the mating pin or protrusion to enter the cam path, latch in the nest and unlatch while leaving the cam path, as is described herein.

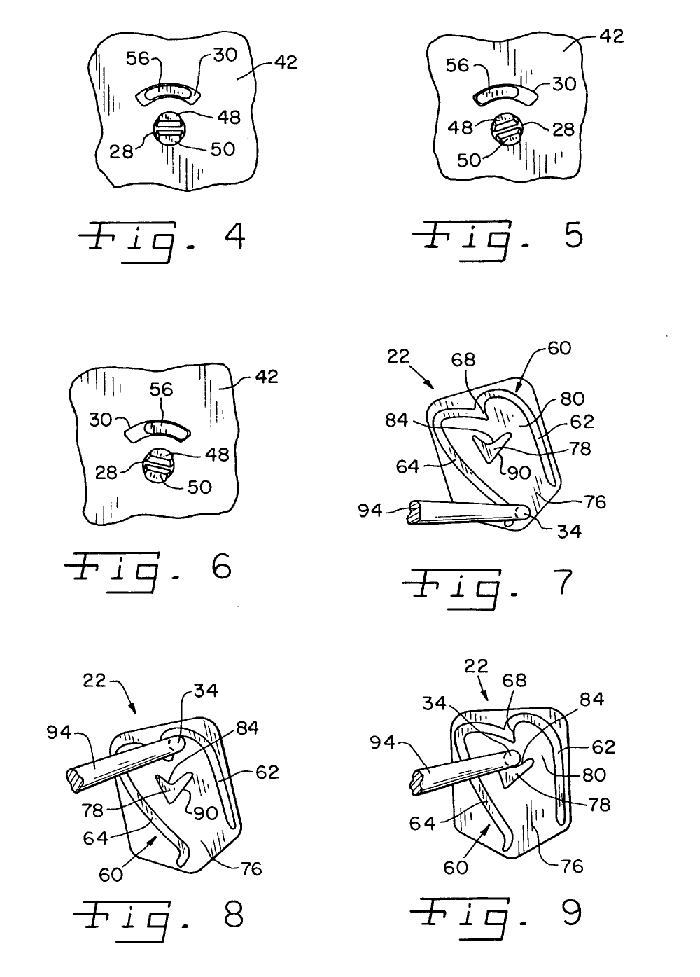

FIGS. 4, 5 and 6 illustrate the limited movement of latch mechanism 22 relative to housing 24 during latching and unlatching procedures. FIGS. 9-12 illustrate various positions of the pin or protrusion 34 during latching and unlatching, and various positions of latch mechanism 22 as latch mechanism 22 pivots about an axis defmed by snap connector 46, with movement being limited by boss 56 in arcuate slot 30. An arm 94 is shown connected to protrusion 34 in FIGS. 7-10, to better illustrate the manner in which latch body 40 tilts relative to the rotational axis about which protrusion 34 travels.

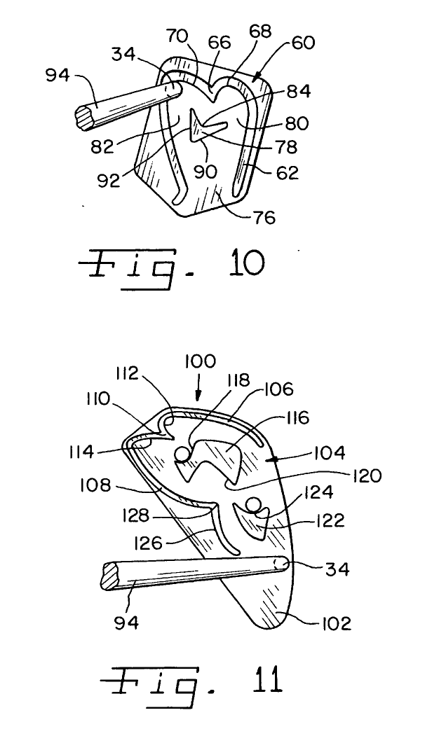

From an opened position, bin 20 is closed by raising door 26. Protrusion 34 enters latch configuration 60 through portal 76 and follows along entrance wall portion 62, guided as necessary by entrance guide wall 90. As lifting pressure is applied and protrusion 34 slides along entrance wall portion 62, latch mechanism 22 is caused to tilt toward the pivotal axis controlling the path along which protrusion 34 travels, axis 32 in the exemplary embodiment of bin 20. Continued lifting of door 26 continues the traversing of entrance path 80 by protrusion 34 until protrusion 34 is fully raised at the juncture of entrance wall portion 62 and entrance side 68 of redirecting feature 66 (FIG. 8). A person closing bin 20 will naturally release lifting pressure as no further movement of door 26 occurs. As lifting force is relieved, protrusion 34 follows entrance side 68 and drops into settling point 84 (FIG. 9) as latch mechanism 22 rotates to a more centered position (FIG. 4).

When bin 20 is to be opened, door 26 is again lifted slightly. Protrusion 34 is raised from settling point 84 and encounters exit side 70 of redirecting feature 66. Protrusion 34 slides along exit side 80 to a juncture of exit side 80 and exit wall 64 as latch mechanism 22 tilts away from the rotational axis about which protrusion 34 travels (FIG. 10). As the person opening bin 20 encounters resistance to further lifting, lifting pressure is relieved and door 26 falls open as protrusion 34 follows along exit wall portion 64 and exit path 82.

Tilting of latch mechanism 22 both toward and away from the rotational axis controlling the path of protrusion 34 facilitates smooth, consistent operation in a pivoting closure with protrusion 34 moving along an arc from the pivot point of axis 32.

FIG. 11 illustrates a further embodiment of the present invention for a latch mechanism 100, and more specifically an operating face 102 thereof. Latch 100 is provided with a mounting face (not shown) similar to mounting face 42, and is pivotally mounted for controlled tilting back an forth during operation as described for latch mechanism 22, such as by mounting a snap connector 46 in a hole 28 and positioning a boss 56 in a slot 30.

Operating face 102 defines a latch configuration 104 including an outer wall having an entrance wall portion 106, a first exit wall portion 108 and a first redirecting feature 110 having both an entrance side 112 and an exit side 114. A first latch nest 116 is disposed between and spaced from entrance wall portion 106 and exit wall portion 108 and generally beneath and spaced from redirecting feature 110. Latch nest 116 is a generally heart-shaped configuration forming a settling point 118 defining the closed position for pin or protrusion 34, but can be any suitable configuration in accordance with the present invention. At the opposite side of latch nest 116 from settling point 118 a second redirecting feature 120 is provided. Second redirecting feature 120 operates in conjunction with a second latch nest 122 having a second settling point 124 for securing the latch mechanism in a partly opened condition. A second exit wall portion 126 joins with first exit wall portion 108 at a directing point 128 to direct protrusion 34 toward second redirecting feature 120 and second latch nest 122.

A two-stage latch mechanism 100 as illustrated in FIG. 11 is operated in push-push operations. The user pushes a bin or the like to open it, and as the bin rotates open, the user interrupts the motion at an intermediate position between the fully closed and fully open positions by pushing the bin again upward slightly. When fully closed, a protrusion 34 is held in first latch nest 116, and in a partly open condition protrusion 34 is held in second latch nest 122. To fully open the device from the partly opened condition the device is again pushed to dislodge the protrusion from second latch nest 122 and permit movement of the protrusion to the fully open position.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A latch comprising:
a protrusion movable in an arc;
a push-push latch configuration having an entrance wall portion, an exit wall portion and a redirecting feature between said entrance wall portion and said exit wall portion, and a nest having a settling point for receiving said protrusion; and
said latch configuration being pivotal about an axis for movement in an arc as said protrusion traverses paths entering and exiting said latch configuration.

2. The latch of claim 1, said latch configuration being one face of a latch body, and an opposite face of said latch body defining a boss for controlling arcuate movement of said body.

3. The latch of claim 2, said opposite face of said body defining a snap connector for mounting said body, and said body being pivotal about said snap connector.

4. The latch of claim 1, said latch configuration being one face of a latch body, and an opposite face of said latch body defining a snap connector for mounting said body and defining a pivotal axis for movement of said body.

5. The latch of claim 1, said latch configuration including two said latch nests and two said settling points.

6. The latch of claim 5, said latch configuration being one face of a latch body, and an opposite face of said latch body defining a boss for controlling arcuate movement of said body.

7. The latch of claim 5, said latch configuration being one face of a latch body, and an opposite face of said latch body defining a snap connector for mounting said body and defining a pivotal axis for movement of said body.

8. The latch configuration of claim 7, said opposite face of said body defining a boss for controlling arcuate movement of said body.

9. A latchable structure comprising:
a first component having a hole and an arcuate slot;
a latch body having first and second faces, said first face having a snap connector disposed in said hole and a boss disposed in said arcuate slot, said second face having a push-push latch configuration including a latch nest;
said latch body being rotatable about said snap connection in said hole, and the rotation thereof being limited by said boss in said arcuate slot; and
a second component movable about a pivotal axis for opening and closing said structure, said second component having a protrusion movable in an arc and operating within said push-push latch configuration including being retained in said latch nest to secure a position of said second component relative to said first component.

10. The latchable structure of claim 9, said second face having first and second latch nests for retaining said protrusion to secure a first position and a second position of said second component relative to said first component.

11. A method for operating a latch, comprising steps of:
moving a protrusion in an arc;
providing a push-push latch configuration; and
tilting the latch configuration from one position to another position about a rotational axis while moving the protrusion within the latch configuration.

12. The method of claim 11, including latching the latch while performing said moving and said tilting steps.

13. The method of claim 11, including unlatching the latch while performing said moving and said tilting steps.

14. The method of claim 11, including performing said moving and said tilting steps for both latching and unlatching the latch.

15. The method of claim 11, including providing a first and a second latch nest, and positioning said protrusion in one of said nests.

16. The method of claim 15, including performing said moving and said tilting steps while moving said protrusion into one of said nests.

17. The method of claim 15, including performing said moving and said tilting steps while moving said protrusion out of one of said nests.

18. The method of claim 17, including performing said moving and said tilting steps when moving said protrusion from one of said nests to the other of said nests.

19. The method of claim 11, including a step of providing fixed stops and limiting said tilting by engaging the fixed stops.

20. The method of claim 19 including providing a first and a second latch nest, and positioning said protrusion in one of said nests.
